(19) United States
(12) Patent Application Publication
(10) Pub. No.: US 2009/0064247 A1
(43) Pub. Date: Mar. 5, 2009

(54) USER GENERATED CONTENT

(75) Inventors: Bryan Biniak, Los Angeles, CA (US); Chris Cunningham, Los Angeles, CA (US); Atanas Ivanov, Santa Monica, CA (US); Jeffrey Marks, Sherman Oaks, CA (US); Brock Meltzer, Los Angeles, CA (US)

Correspondence Address: DLA PIPER US LLP, 1999 AVENUE OF THE STARS, SUITE 400, LOS ANGELES, CA, 90067-6023, US

(73) Assignee: JACKED, INC., SANTA MONICA, CA (US)

(21) Appl. No.: 12/203,123

(22) Filed: Sep. 2, 2008

Related U.S. Application Data
(60) Provisional application No. 60/969,470, filed on Aug. 31, 2007.

(51) Int. Cl. H04N 7/173

(52) U.S. Cl. 725/105

(57) ABSTRACT

The system provides a computer based presentation synchronized to a broadcast and not merely to an event. The system includes a customizable interface that uses a broadcast and a plurality of secondary sources to present data and information to a user to enhance and optimize a broadcast experience. The secondary sources can comprise commercially available sources as well as user generated content that is generated prior to, or coincidentally with, the broadcast of the primary content.

This patent application claims priority to U.S. Provisional Patent application No. 60/969,470 filed on Aug. 31, 2007 and entitled “User Generated Content” which is incorporated by reference herein in its entirety.

### BACKGROUND OF THE SYSTEM

Attempts have been made in the prior art to provide a computer experience coordinated with an event on television. For example, there are devices (such as the “slingbox”) that allow a user to watch his home television on any computer. However, this is merely a signal transfer and there are no additional features in the process.

Another approach is to supplement a television program with a simultaneous internet presentation. An example of this is known as “enhanced TV” and has been promoted by espn.com. During an enhanced TV broadcast, such as of a sporting event, a user can also log onto espn.com and see statistics and other information associated with the game being played. One limitation with enhanced TV is that it is tied to the event (i.e. game) and not to the broadcast. Another limitation is that the data is typically historical data that is tied to the appearance of a specific player. For example, in a baseball game, when a particular player is at bat, the historical statistics for that player are shown. The system is not reactive but rather is a static presentation of facts that are determined in advance. Another disadvantage is that the user is limited to only the data made available by the website, and has no ability to customize the data that is being associated with the game.

Other approaches include silverlight.com, netvibes.com, pageflix.com, urminis, etc. but these are predominantly user interfaces for watching TV and are not tied to a broadcast and/or secondary sources.

All of the prior art systems lack customizable tuning of secondary content, user alerts, social network integration, interactivity, and synchronization to a broadcast instead of to an event.

### BRIEF SUMMARY OF THE SYSTEM

The system provides a computer based presentation synchronized to a broadcast and not merely to an event. The system includes a customizable interface that uses a broadcast and a plurality of secondary sources to present data and information to a user to enhance and optimize a broadcast experience. The secondary sources can comprise commercially available sources as well as user generated content that is generated prior to, or coincidentally with, the broadcast of the primary content.

### BRIEF DESCRIPTION OF THE DRAWINGS

FIG. 1 illustrates the high level flow of information and content through the Social Media Platform;

FIG. 2 illustrates the content flow and the creation of generative media via a Social Media Platform;

FIG. 3 illustrates the detailed platform architecture components of the Social Media Platform for creation of generative media and parallel programming shown in FIG. 2; and

FIGS. 4-6 illustrate an example of the user interface for an implementation of the Social Media Platform and the Parallel Programming experience.

FIG. 7 is a block diagram of an embodiment of the system.

FIG. 8 is a flow diagram illustrating the collection of user generated content.

FIG. 9 is a flow diagram illustrating translanguage operation.

FIG. 10 is an example computer environment for implementing the system in one embodiment.

### DETAILED DESCRIPTION OF THE SYSTEM

The present system provides a method for collecting and displaying context relevant content generated by users. In the following description, numerous specific details are set forth to provide a more thorough description of the system. It will be apparent, however, that the system may be practiced without these specific details. In other instances, well know features have not been described in detail.

Social Media Platform

In one embodiment, the invention is particularly applicable to a Social Media Platform in which the source of the original content is a broadcast television signal and it is in this context that the invention will be described. It will be appreciated, however, that the system and method has greater utility since it can be used with a plurality of different types of original source content.

The ecosystem of the Social Media Platform may include primary sources of media, generative media, participatory media, generative programming, parallel programming, and accessory devices. The Social Media Platform uses the different sources of original content to create generative media, which is made available through generative programming and parallel programming (when published in parallel with the primary source of original content). The generative media may be any media connected to a network that is generated based on the media coming from the primary sources. The generative programming is the way the generative media is exposed for consumption by an internal or external system. The parallel programming is achieved when the generative programming is contextually synchronized and published in parallel with the transmitted media (source of original content). The participatory media means that third parties can produce generative media, which can be contextually linked and tuned with the transmitted media. The accessory devices of the Social Media Platform and the parallel programming experience may include desktop or laptop PCs, mobile phones, PDAs, wireless email devices, handheld gaming units and/or PocketPCs that are the new remote controls.

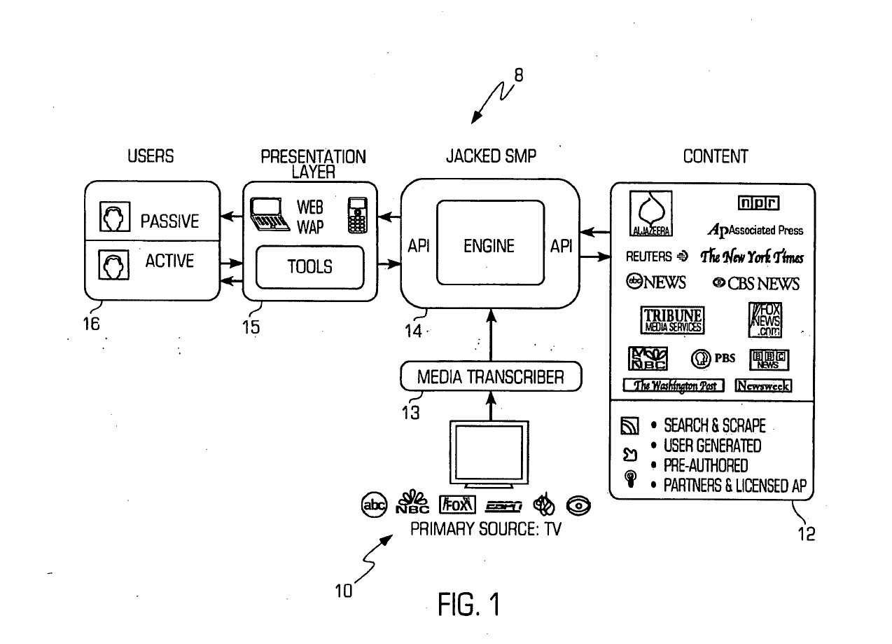

FIG. 1 illustrates the high level flow of information and content through the Social Media Platform 8. The platform may include an original content source 10, such as a television broadcast, with a contextual secondary content source 12, that contains different content wherein the content from the original content source is synchronized with the content from the contextual content source so that the user views the original content source while being provided with the additional content contextually relevant to the original content in real time.

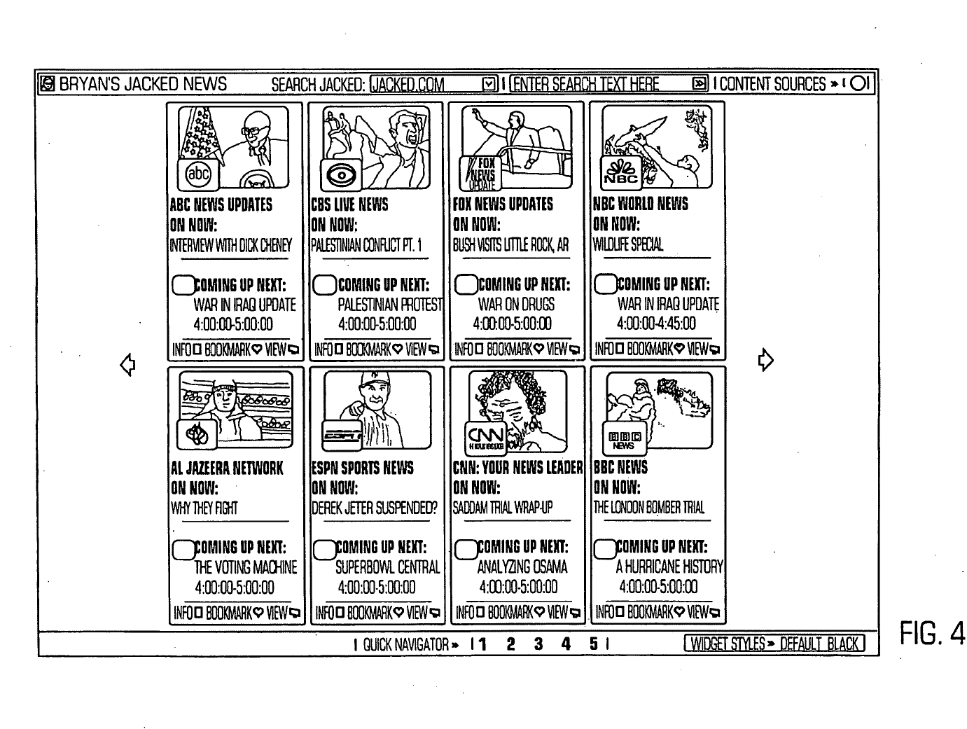

The contextual content source 12 may include different types of contextual media including text, images, audio, video, advertising, commerce (purchasing) as well as third party content such as publisher content (such as Time, Inc., XML), web content, consumer content, advertiser content and retail content. An example of an embodiment of the user interface of the contextual content source is described below with reference to FIGS. 4-6. The contextual content source 12 may be generated/provided using various techniques such as search and scrape, user generated, pre-authored and partner and licensed material.

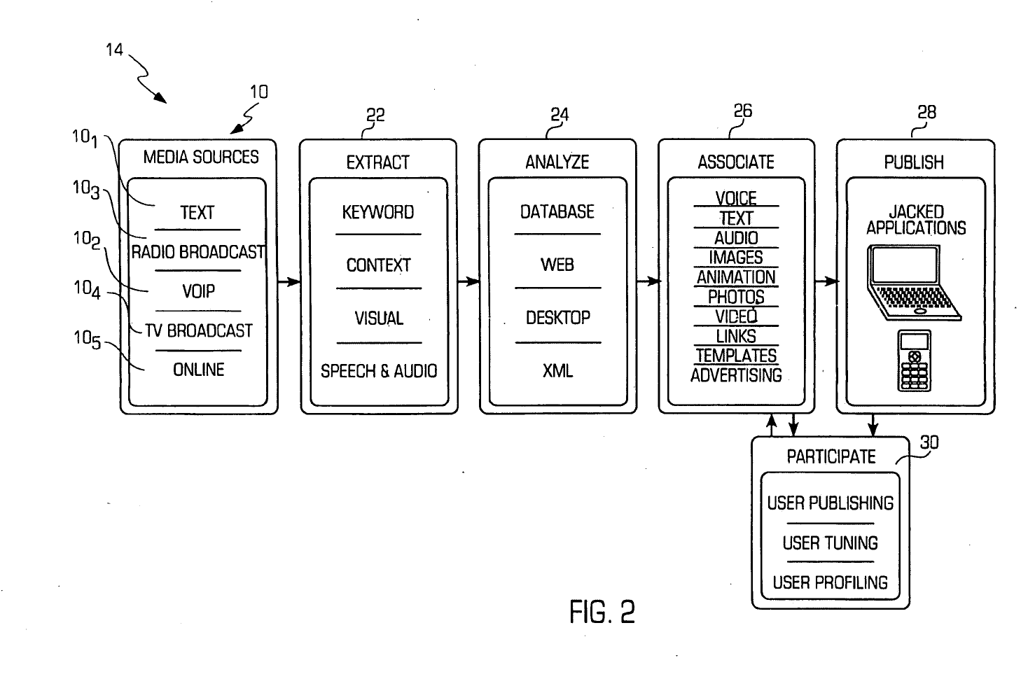

The original/primary content source 10 is fed into a media transcriber 13 that extracts information from the original content source which is fed into a social media platform 14 that contains an engine and an API for the contextual content and the users. The Social Media Platform 14 at that point extracts, analyzes, and associates the Generative Media (shown in more detail in FIG. 2) with content from various sources. Contextually relevant content is then published via a presentation layer 15 to end users 16 wherein the end users may be passive and/or active users. The passive users will view the original content in synchronization with the contextual content while the active users will use tools made accessible to the user to tune content, create and publish widgets, and create and publish dashboards. The users may use one device to view both the original content and the contextual content (such as television in one embodiment) or use different devices to view the original content and the contextual content (such as on a web page as shown in the examples below of the user interface).

The social media platform uses linear broadcast programming (the original content) to generate participative, parallel programming (the contextual/secondary content wherein the original content and secondary content may be synchronized and delivered to the user. The social media platform enables viewers to jack-in into broadcasts to tune and publish their own content. The social media platform also extends the reach of advertising and integrates communication, community and commerce together.

FIG. 2 illustrates content flow and creation of generative media via a Social Media Platform 14. The system 14 accesses the original content source 10 and the contextual/secondary content source 12 shown in FIG. 1. As shown in FIG. 2, the original content source 10 may include, but is not limited to, a text source 10₁, such as Instant Messaging (IM), SMS, a blog or an, email, a voice over IP source 10₂, a radio broadcast source 10₃, a television broadcast source 10₄ or a online broadcast source 10₅, such as a streamed broadcast. Other types of original content sources may also be used (even those yet to be developed original content sources) and those other original content sources are within the scope of the invention since the invention can be used with any original content source as will be understood by one of ordinary skill in the art. The original content may be transmitted to a user over various medium, such as over a cable, and displayed on various devices, such as a television attached to the cable, since the system is not limited to any particular transmission medium or display device for the original content. The secondary source 12 may be used to create contextually relevant generative content that is transmitted to and displayed on a device 28 wherein the device may be any processing unit based device with sufficient processing power, memory and connectivity to receive the contextual content. For example, the device 28 may be a personal computer or a mobile phone (as shown in FIG. 2), but the device may also be PDAs, laptops, wireless email devices, handdheld gaming units and/or PocketPCs. The invention is also not limited to any particular device on which the contextual content is displayed.

The social media platform 14, in this embodiment, may be a computer implemented system that has one or more units (on the same computer resources such as servers or spread across a plurality of computer resources) that provide the functionality of the system wherein each unit may have a plurality of lines of computer code executed by the computer resource on which the unit is located that implement the processes and steps and functions described below in more detail. The social media platform 14 may capture data from the original content source and analyze the captured data to determine the context/subject matter of the original content, associate the data with one or more pieces of contextual data that is relevant to the original content based on the determined context/subject matter of the original content and provide the one or more pieces of contextual data to the user synchronized with the original content. The social media platform 14 may include an extract unit 22 that performs extraction functions and steps, an analyze unit 24 that performs an analysis of the extracted data from the original source, an associate unit 26 that associates contextual content with the original content based on the analysis, a publishing unit 28 that publishes the contextual content in synchronism with the original content and a participatory unit 30.

The extraction unit 22 captures the digital data from the original content source 10 and extracts or determines information about the original content based on an analysis of the original content. The analysis may occur through keyword analysis, context analysis, visual analysis and speech/audio recognition analysis. For example, the digital data from the original content may include close captioning information or metadata associated with the original content that can be analyzed for keywords and context to determine the subject matter of the original content. As another example, the image information in the original content can be analyzed by a computer, such as by video optical character recognition to text conversion, to generate information about the subject matter of the original content. Similarly, the audio portion of the original content can be converted using speech audio recognition to obtain textual representation of the audio. The extracted closed captioning and other textual data is fed to an analysis component which is responsible for extracting the topic and the meaning of the context. The extract unit 22 may also include a mechanism to address an absence or lack of close caption data in the original content and/or a mechanism for addressing too much data that may be known as “informational noise.”

Once the keywords/subject matter/context of the original content is determined, that information is fed into the analyze unit 24 which may include a contextual search unit. The analysis unit 24 may perform one or more searches, such as database searches, web searches, desktop searches and/or XML searches, to identify contextual content in real time that is relevant to the particular subject matter of the original content at the particular time. The resultant contextual content, also called generative media, is then fed into the association unit 26 which generates the real-time contextual data for the original content at that particular time. As shown in FIG. 2, the contextual data may include, for example, voice data, text data, audio data, image data, animation data, photos, video data, links and hyperlinks, templates and/or advertising.

The participatory unit 30 may be used to add other third party/user contextual data into the association unit 26. The participatory contextual data may include user publishing information (information/content generated by the user or a third party), user tuning (permitting the user to tune the contextual data sent to the user) and user profiling (that permits the user to create a profile that will affect the contextual data sent to the user). An example of the user publishing information may be a voiceover of the user which is then played over the muted original content. For example, a user who is a baseball fan might do the play-by-play for a game and then play his play-by-play while the game is being played wherein the audio of the original announcer is muted which may be known as fan casting.

The publishing unit 28 may receive data from the association unit 26 and interact with the participatory unit 30. The publishing unit 28 may publish the contextual data into one or more formats that may include, for example, a proprietary application format, a PC format (including for example a website, a widget, a toolbar, an IM plug-in or a media player plug-in) or a mobile device format (including for example WAP format, JAVA format or the BREW format). The formatted contextual data is then provided, in real time and in synchronization with the original content, to the devices 16 that display the contextual content.

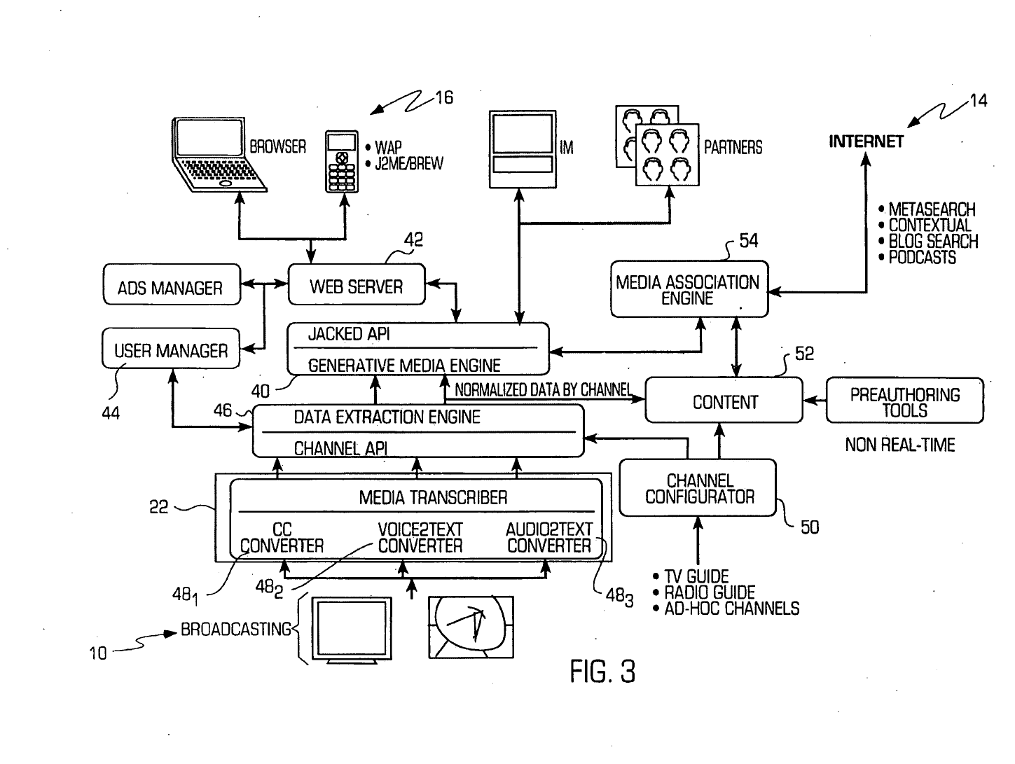

FIG. 3 illustrates more details of the Social Media Platform for creation of generative media and parallel programming shown in FIG. 2 with the original content source 10, the devices 16 and the social media platform 14. The platform may further include a Generative Media engine, 40 (that contains a portion of the extract unit 22, the analysis unit 24, the associate unit 26, the publishing unit 28 and the participatory unit 30 shown in FIG. 2) that includes an API wherein the IM users and partners can communicate with the engine 40 through the API. The devices 16 communicate with the API through a well known web server 42. A user manager unit 44 is coupled to the web server to store user data information and tune the contextual content being delivered to each user through the web server 42. The platform 14 may further include a data processing engine 46 that generates normalized data by channel (the channels are the different types of the original content) and the data is fed into the engine 40 that generates the contextual content and delivers it to the users. The data processing engine 46 has an API that receives data from a close captioning converter unit 48₁ (that analyzes the close captioning of the original content), a voice to text converter unit 48₂ (that converts the voice of the original content into text) so that the contextual search can be performed and an audio to text converter unit 48₃ (that converts the voice of the original content into text) so that the contextual search can be performed wherein each of these units is part of the extract unit 22. The close captioning converter unit 48₁ may also perform filtering of “dirty” close captioning data such as close captioning data with misspellings, missing, words, out of order words, grammatical issues, punctuation issues and the like.

The data processing engine 46 also receives input from a channel configurator 50 that configures the content for each different type of content. The data from the original content and the data processed by the data processing engine 46 are stored in a data storage unit 52 that may be a database. The database also stores the channel configuration information, content from the preauthoring tools (which is not in realtime) and search results from a search coordination engine 54 used for the contextual content. The search coordination engine 54 (part of the analysis unit 24 in FIG. 2) coordinates the one or more searches used to identify the contextual content wherein the searches may include a metasearch, a contextual search, a blog search and a podcast search.

FIGS. 4-6 illustrate an example of the user interface for an implementation of the Social Media Platform. For example, when a user goes to the system, the user interface shown in FIG. 4 may be displayed. In this user interface, a plurality of channels (such as Fox News, BBC News, CNN Breaking News) are shown wherein each channel displays content from the particular channel. It should be noted, that each of the channels may also be associated with one or more templates to present the secondary source data to the user. The templates may be automatically selected based on the broadcast on that channel, or may be manually selected by the user.

Although the interface of FIG. 4 is illustrated as a plurality of available channels such as is consistent with the operation of a television, it should be understood that the interface can be configured by event or even type of event. For example, one tile could represent football with drill down possibilities to college or pro football, and drill down to all available games in each sport.

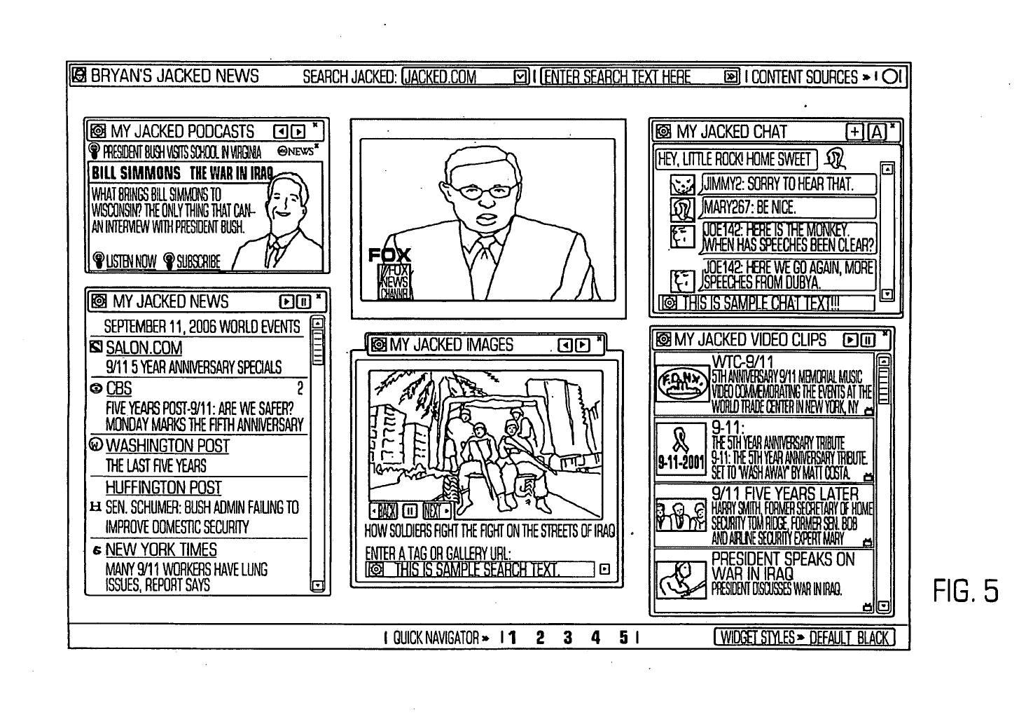

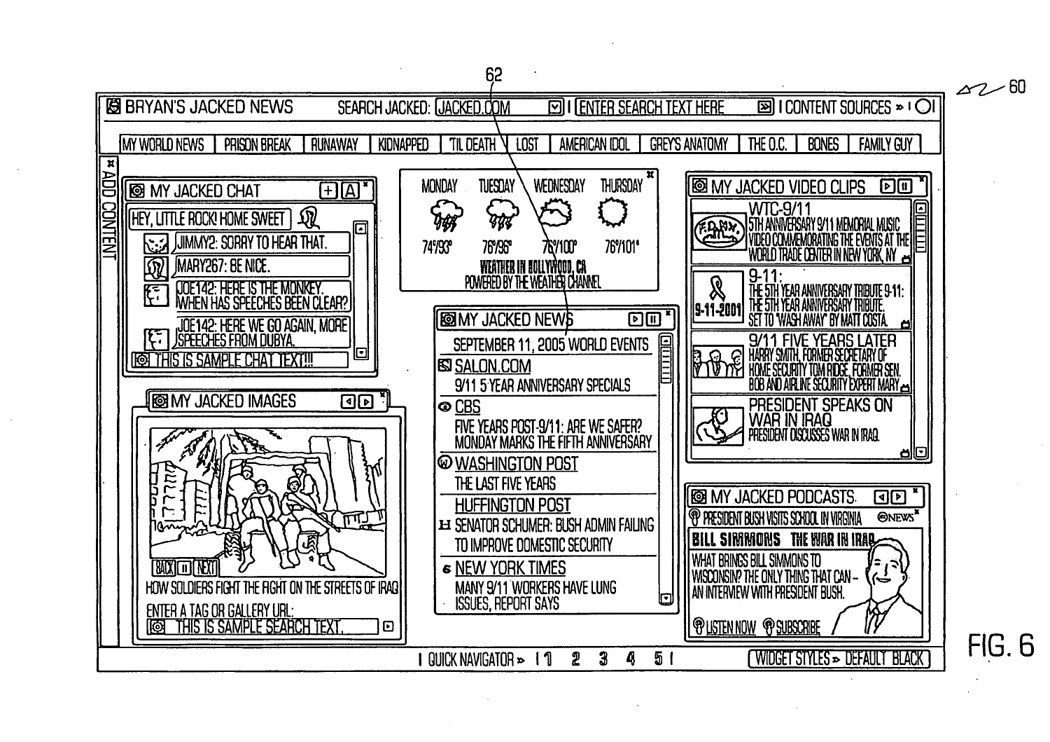

When a user selects the Fox News channel, the user interface shown in FIG. 5 is displayed to the user which has the Fox News content (the original content) in a window along with one or more contextual windows that display the contextual data that is related to what is being shown in the original content. In this example, the contextual data may include image slideshows, instant messaging content, RSS text feeds, podcasts/audio and video content. The contextual data shown in FIG. 5 is generated in real-time by the Generative Media engine 40 based on the original content capture and analysis so that the contextual data is synchronized with the original content. FIG. 6 shows an example of the webpage 60 with a plurality of widgets (such as a “My Jacked News”+widget 62, “My Jacked Images” widget, etc.) wherein each widget displays contextual data about a particular topic without the original content source being shown on the same webpage.

User Generated Content

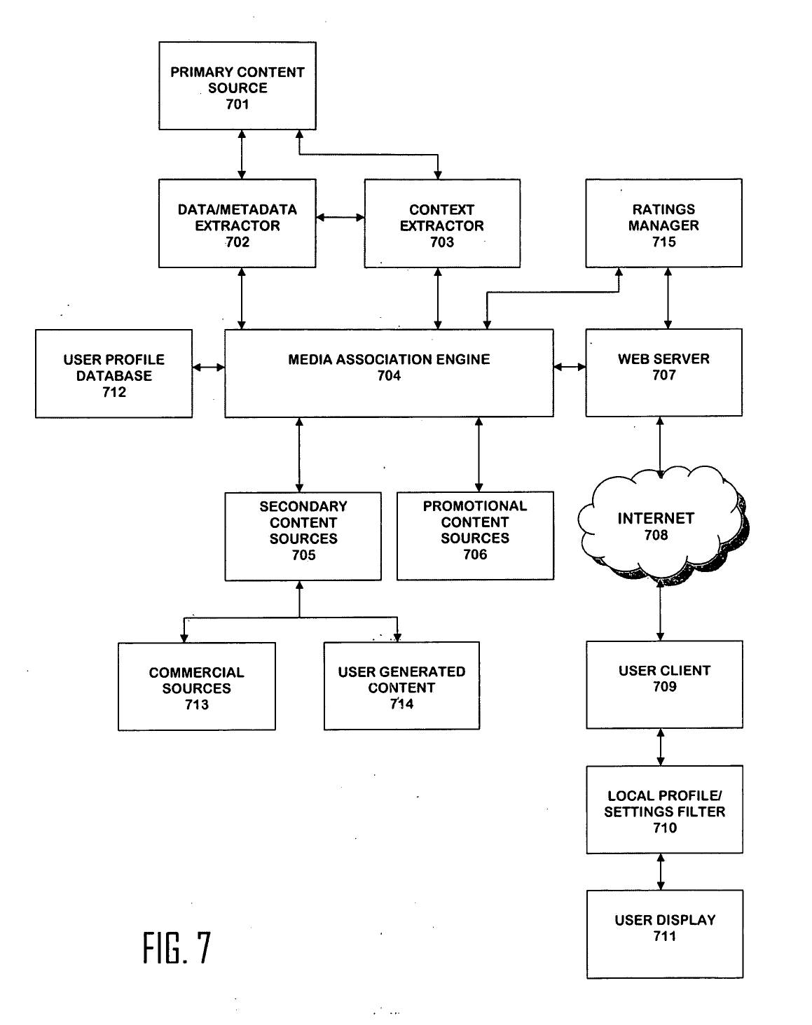

FIG. 7 is a functional block diagram illustrating an embodiment of the system that illustrates the inclusion of user generated content. Block 701 is a primary content source. The primary content source may be a television broadcast or any other suitable primary content source. The primary content source 701 is coupled to data/metadata extractor 702 and context extractor 703. The data/metadata extractor 702 extracts metadata such as cc text, audio data, image data, and other related metadata, as well as data from the primary content source itself. The context extractor 703 is coupled to the primary content source 701 and to the data/metadata extractor 702 and is used to extract context information about the primary content source 701.

The data/metadata extractor 702 and context extractor 703 provide output to media association engine 704. The media association engine 704 uses the metadata and context data to determine what secondary content and promotional content to be provided to a user. The media association engine 704 is coupled to a user profile database 712 which contains profile information about the registered users of the system. The media association engine 704 provides requests to secondary content source 705 and promotional content source 706.

Secondary content source 705 can draw content from commercial sources 705 such as from one or more web sites, databases, commercial data providers, or other sources of secondary content. The request for data may be in the form of a query to an internet search engine or to an aggregator web site such as Youtube, Flickr, or other user generated media sources. Alternatively, the secondary content can be user generated content 714. This user generated content can be chats, blogs, homemade videos, audio files, podcasts, images, or other content generated by users. The users may be participating and/or registered users of the system or may be non-registered third parties.

The promotional content sources 706 may be a local database of prepared promotional files of one or more media types, or it could be links to servers and databases of advertisers or other providers of promotional content. In one embodiment, the promotional content may be created dynamically, in some cases by “mashing” portions of the secondary content with promotional content.

The media association engine 704 assembles secondary content and promotional content to send to users to update user widgets. The assembled content is provided via web server 707 to a user, such as through the internet 108. A user client 709 receives the assembled secondary and promotional content updates and applies a local profile/settings filter 710. This filter tracks the active widgets of the user, team preferences, client processing capabilities, user profile information, and other relevant information to determine which widgets to update and with which information. User display 711 displays user selected widgets and are updated with appropriate content for presentation to the user.

The system includes a ratings manager 715 coupled to the media association engine 704 and the web server 707. The ratings manager 715 receives information about the primary content source, the secondary content source, user behaviour and interaction, user profile information, and metadata relating to the primary content, secondary content, and promotional content.

The ratings manager 715 can detect traditional ratings information such as the presence, or absence of a viewer of the primary content. In addition, the ratings manager 715 has access to the user profile data and for all users accessing the system. So the system can not only provide comprehensive statistical information about the viewing and viewing interest of a user, but important demographic information as well. The system can provide real time and instantaneous geographic, age based, income based, gender based, and even favourite team based, data relating the response and viewer-ship of consumers of the primary content.

Found Content

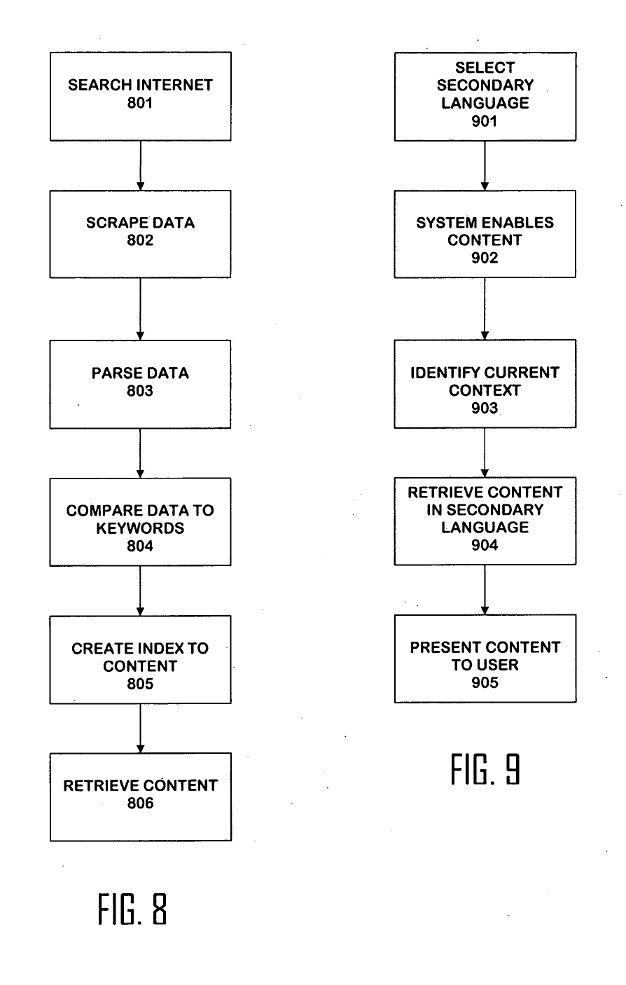

The user generated content allows users to interact in real time about an event that they are experiencing together (e.g. the primary content broadcast). The system can utilize both found and provided user generated content. Found content includes user generated content that is found as the result of queries to sites that may include some or all user generated content (YouTube, Flickr, etc.). FIG. 8 illustrates one embodiment for finding user generated content. At step 801 the system searches web sites that may be the source of user generated content. The system directs its searches to content sources that can be “scraped” i.e. the data located on the site can be determined by retrieving indicators that reveal the nature and characteristics of the data and content.

At step 802 the system scrapes a site and collects the meta data associated with content on the site. At step 803 the system parses the scraped data so that relevancy to a broadcast event may be determined. At step 804 the system compares the data to key words stored in the system. This may take place in the media association engine. At step 805 the system creates an index to data that can be used in the system. For example, if the system is directed to sports presentations, only content that has a sports association is indexed. The index includes the keywords as well as the location of the data so that it can be retrieved as desired. Some data, such as images, may have a brief description that can be used to index and categorize the content and data. At step 806, the system retrieves the data when a context is such that the data is appropriate. In one embodiment, the system may generate a context score for the data so that the appropriateness of the data for a given context can be determined and that data that is more highly scored can be retrieved first.

Nominated User Generated Content

Provided content can be prepared content by a user that relates generally to the event (e.g. team or player discussions in blogs and podcasts, image, video, and/or audio presentations, etc.). Provided content can also be real-time generated content that is being provided during the primary content broadcast (e.g. podcasting, chatting, etc.). In one embodiment, the user generated content can be voluntarily identified to the system via a sign up process. A user may nominate the user's generated content or some other source of generated content. In these situations, the user offering the content is provided with guidelines for handling the content. These guidelines include rules for identifying the content using metadata, including metadata format and desired terms. The system then establishes a link to the content and scrapes it periodically to index the content so that it can be provided at the appropriate time. The system may even set up a specific website for the submission of user generated content. The system requires the submitter to provide certain metadata associated with content that is uploaded so that the user generated content can be searched and indexed.

In one embodiment, the system includes a widget that is team based. The widget may be utilized to present chat content. However, the widget detects whose supporters of a team are more active on the chat, and weights the presentation of content towards that team. The weighting may be such that the more active supporters take complete control of the widget while they are more active, or it may be that some percentage of presentation capacity is dedicated to the more active supporters.

In another embodiment, the user generated content is filtered based on which team is winning or losing at the time (e.g. only content associated with the winning team is presented to each user regardless of that user's favourite team).

In another embodiment, users of the system notify the system that they are willing and able to provide content. In those cases where the system performs queries for content, the URL's of the users source of secondary content is included as a resource of the content search. In some cases, content might come from users actually attending the event. For example, viewers at a sporting event might take still or video images of the event and make them available for use during and after the broadcast.

Translanguage

The system uses one language for presentation and content in one embodiment. In another embodiment, the system can provide content in one or more languages. A user can elect to receive secondary content from a foreign language source if desired. This process is illustrated in FIG. 9. At step 901 the user selects a secondary language that the user desires to see. At step 902 the system enables content in that language to be provided. This content has previously been identified by using translated version of keywords and contextual circumstances. At step 903 the system identifies the current context of a broadcast. At step 904 the system retrieves translanguage content appropriate for that context and provides it to the user at step 905. The ability to retrieve translanguage content enables a single user interface to be used without the need to build an interface in each language, while still allowing the provision of content in multiple languages.

Example Computer System

Embodiment of Computer Execution Environment (Hardware)

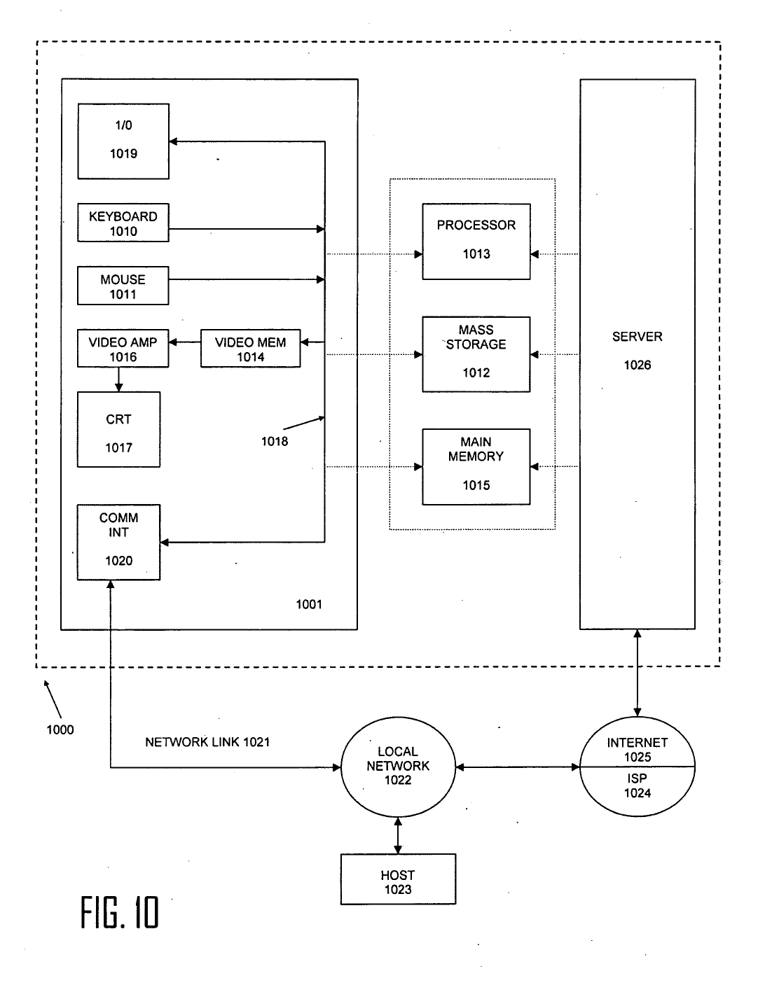

An embodiment of the system can be implemented as computer software in the form of computer readable program code executed in a general purpose computing environment such as environment 1000 illustrated in FIG. 10, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU 1013. Other suitable input devices may be used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a microprocessor such as manufactured by Intel, AMD, Sun, etc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a taster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code maybe executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at, server 1026, are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method for presenting secondary content associated with primary content comprising:
generating user content related to the event;
collecting and presenting the user generated content coordinated with the primary content.

2. The method of claim 1 wherein the step of collecting the user generated content comprises scraping data from a user generated content source.

3. The method of claim 1 wherein the user, generated content source includes metadata associated with content.

4. The method of claim 3 wherein secondary content having metadata associated with the primary content is presented to the user.

5. The method of claim 4 further including the step of the user defining a category of secondary content.

6. The method of claim wherein the category comprises image data.

7. The method of claim 5 wherein the category comprises video data.

8. The method of claim 5 wherein the category comprises audio data.

9. The method of claim 5 wherein the category comprises textual data.

10. The method of claim 1 wherein the secondary content is in a secondary language.
